(19) United States
(12) Patent Application Publication
(10) Pub. No.: US 2025/0284711 A1
(43) Pub. Date: Sep. 11, 2025

(54) COMPUTER-BASED SYSTEMS CONFIGURED TO DETERMINE ELEMENT-LEVEL DATA LINEAGE AND METHODS OF USE THEREOF

(71) Applicant: Capital One Services, LLC, McLean, VA (US)

(72) Inventors: Christopher Cellucci, Scotts Valley, CA (US); Selwyn Lehmann, Hughson, CA (US); Saianirudh Kantabathina, Fremont, CA (US); Samuel Joshua Bennett, Midlothian, VA (US); Alec Sokol, San Francisco, CA (US)

(21) Appl. No.: 18/595,701

(22) Filed: Mar. 5, 2024

(51) Int. Cl. G06F 16/28

(52) U.S. Cl. CPC G06F 16/287

(57) ABSTRACT

In some embodiments, the present disclosure provides an exemplary technically improved computer-based method utilizing an element level mapping module that determines a correlative relationships of interconnected nodes and edges in relation to an output data element and an input data element, and determines an appropriate graph of the relationships.

### FIELD OF TECHNOLOGY

The present disclosure generally relates to computer-based systems that include a lineage module that generates element-level data lineage mapping based on a correlation between interconnected data elements such as between an input data element and an output data element and graphs the data lineage mapping and methods of use thereof.

### BACKGROUND OF TECHNOLOGY

An enterprise database typically has numerous applications operating simultaneously, those applications are actively altered by process/parameter, data, other applications etc. The record of those processes is a data lineage record. Data lineage is a record of the relationships between datasets, applications, or manual input that they actively interact with. A typical data lineage record for even a mid-size database could include millions of changes. Data lineage records provide insights into how efficient applications, processes, and data storage are in the system, and so it is important to understand data lineage records.

### SUMMARY OF DESCRIBED SUBJECT MATTER

Large data lineage records are difficult to record and track, thus a solution is needed that provides a system of generating data lineage records of a database. In some embodiments, the present disclosure provides an exemplary technically improved computer-based method that includes at least the following steps: retrieving by at least one processor, a first data element for mapping an element-level mapping, the first data element representing an output data element having a plurality of interconnected nodes and edges in a graph database related to a second data element representing an input data element; utilizing, by at least one processor, an element mapping module, to determine a correlation in a graph database based at least in part on the first data element and the second data element; wherein the element mapping module is configured to: utilize at least one element-level mapping model to determine a statistical relationship between a plurality of data elements comprising a plurality of interconnected nodes and edges in a graph database; utilizing, by at least one processor, at least one element-level mapping model to determine a correlation between the first data element having interconnected nodes and edges in a graph database and a second element having interconnected nodes and edges in a graph database; utilizing, based on at least one processor, a correlation measurement model to determine correlation between each of the nodes of the first data element and each of the nodes of the second element of the plurality of data elements based on the correlation measurement; sorting, by the at least one processor, the interconnected database elements determined to have a statistically significant correlation to the input data element and the output data element; and, graphing, by the at least one processor, the sorted graph database elements of the nodes and edges determined by the correlation measurement model.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts an illustration of an exemplary computer-based system and platform configured to generate element-level data lineage in a computer-based system, in accordance with one or more embodiments of the present disclosure.

FIG. 2 depicts a block diagram of an exemplary computer-based module for determining data lineage in a computer-based system in accordance with one or more embodiments of the present disclosure.

FIG. 3 is a flowchart illustrating operational steps of automatically determining data lineage from a plurality of data element interactions, in accordance with one or more embodiments of the present disclosure.

FIG. 4 is a diagram illustrating a data lineage graph, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

Data lineage tracking in a database system is important for several reasons. For example, data lineage can be used for diagnostics purposes (e.g., determining resource allocation among applications, run-time errors, etc.,) impact analysis (e.g., data transfer) determining specific application lineage for resource intense applications (e.g., machine learning). It can also be useful in a business sense as some industries in particular (e.g., banking, finance) are subject to specific data transparency requirements, and may be required by regulators to produce evidence of how the terms of an agreement were determined, or how a balance of an account wad modified over the account lifecycle.

Tracking and generating data lineage is a daunting task due to several factors. The significant number of processes operating in a database system, the sheer number of data elements, and the speed at which transformations are carried out on data elements, applications, and processes etc.

Existing solutions for data lineage tracking problems typically belong to one of the following general methods: real-time analysis, element transformation, off-line scanning or parsing. The first method usually relies on a dedicated system that extracts all relevant data lineage information in real time. This system is a brute force method of data lineage collection in that it is computationally expensive, and resource intense in terms of memory allocation. It often requires secondary systems for unifying code language as coding between elements must be resolved to accurately track lineage data. The second method relies on a secondary process and system to create a transformation of lineage data. The transformed data can be stored in persistent storage and later the lineage data for specific processes can be resolved by performing the reverse transformation. The system does not rely on real-time operations to resolve a data lineage graph, but it does require significant off-line resources, secondary systems, and specialized hardware and software development to be implemented. The third method relies on parsing to determine which processes interacted with specific inputs to provide an output data element. The main drawback of this method is that significant element interactions take place during runtime, and scanning/parsing will not resolve these interactions, thus an incomplete at best data lineage graph may be produced from the dataset.

One or more embodiments of this disclosure contemplates a computer-based system having an illustrative lineage module configured to generate an element-level data lineage mapping utilizing a correlation model and produce at least one graph of the mapping. The illustrative system is robust in that it does not consume resources in real-time to resolve element-level mapping of interconnected data elements (e.g., nodes) of an input data element (e.g., node) and output data element (e.g., node). The system does not require transformations or operands, and yet the system is capable of accurately predicting element-level mapping for large scale systems.

In some embodiments, the illustrative lineage module may operate in at least one cloud platform, at least one network, or in a database comprised of at least one server. The illustrative lineage module may retrieve at least one data element that has a record of the relationships/interdependencies between data elements and the software or manual processes that interact with them from the at least one cloud platform, the at least one network, or the at least one database comprised of at least one server. The illustrative lineage module may utilize an internal processor(s), memory and storage to perform element-level mapping of the relationships/interdependencies between data elements and the software or manual processes that interact with them or it may use a processor memory and storage system of an external database, a cloud platform, or network to perform the operations.

In some embodiments, the illustrative lineage module may have a bus capable of communicatively coupling a processor, and a storage device capable of storing data elements and associated data, a system memory (RAM) and ROM for memory storage, an input device such as a keyboard or mouse, an output device such as a monitor, at least one element-mapping engine, correlation measurement engine, and a graphing engine.

In some embodiments of the illustrative lineage module, a process(s) may be described as generating many data elements, each data element having for example an input data element and an output data element. In some embodiments, the input data element and output data element, may be modeled as nodes and edges interconnected by a plurality of nodes in a database. As data elements are modified by different processes the mappings between elements of inputs and outputs are constantly changing, and a complete data element lineage record is difficult to obtain.

In some embodiments, the illustrative computer-based system to generate element-level data lineage may obtain information about the data element from several sources including direct submissions, for example input by a user (e.g., keyboard) by any applications within the system operating on any of a cloud platform, a server database, a network, a virtual machine operating in a network, applications specifically designed to perform element-level mapping of data elements such as parsing applications, storage access logs, or any technique that operates in a similar manner.

In some embodiments, the input data element may be referred to as a source data element and an output element maybe referred to as a target data element. The data elements may be any type of process, and not limited to extract transform load (ETL), a report, a query, an application programming interface load (API), a data entry or any similar type of process.

In some embodiments, the data elements may be retrieved from the processes that exist within the system. The illustrative computer-based system configured to generate element-level data lineage mapping may retrieve documentation of data lineage from an SQL server integration service (SSIS) package, queries, or any other type of process such as for example, selection criteria, multi-table join operations, filters, conditional logic etc.

In some embodiments the computer-based system configured to generate element-level data lineage mapping may utilize at least one correlation algorithm to determine a data lineage correlation of an output data element to its input data element. In some embodiments, the computer-based system configured to generate element-level data lineage mapping may utilize at least one correlation measurement engine to determine an element level data lineage mapping utilizing a correlation algorithm to determine a correlation between each of the interconnected nodes of the interconnected nodes of the previously correlated input and output data element.

In some embodiments the computer-based system configured to generate element-level data lineage mapping may utilize at least one graphing engine to graph the previously determined correlations between the interconnected data elements of the input data element and the output data element.

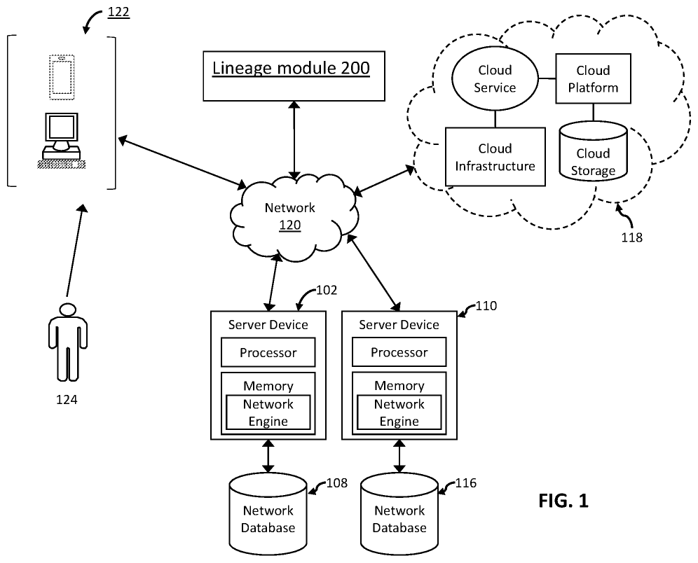

FIG. 1 depicts a block diagram of an exemplary computer-based system and platform configured to generate element-level data lineage, in accordance with one or more embodiments of the present disclosure.

In some embodiments, the illustrative computer-based system of the present disclosure may include a lineage module 200 communicatively coupled to a network 120. The illustrative lineage module 200, may exist as an independent module capable of generating element-level data lineage of processes in a system, or it may exist as part of virtual machine in the network 120, it may also operate in the cloud platform 118, in a server device 102 or server device 110, or it may operate in a device of user 124 for example the device(s) 122. The illustrative lineage module 200 may receive data elements for mapping from any of a network database 108 communicatively coupled to server device 102 or network database 116 communicatively coupled to server device 110, it may also receive data elements from any structure in the cloud platform 118, it may also receive data elements from a device(s) 122, or data elements input by a user 124 into the device(s) 122.

In some embodiments, the illustrative lineage module 200 receives data elements to perform element-level data mapping by any wired or wireless communications medium such as any analog telephone line communication through a modem, any type of wireless communications medium such as WiFi, WiMax, CDMA, satellite, ZigBee, 3G, 4G, 5G, GSM, GPRS, etc., and the like.

In some embodiments, the illustrative computer-based system configured to generate element-level data lineage may be configured to determine a data lineage record of relationships between datasets and the software or manual processes that interact with them. In some embodiments the illustrative computer-based system configured to generate element-level data lineage may be configured to operate in an enterprise database system having at least one operable process that is capable of receiving data and sending data to other processes or systems within the enterprise database system or externally to other systems.

In some embodiments, the illustrative computer-based system configured to generate element-level data lineage may generate a mapping of element level data lineage. The mapping is useful as it is possible to determine for each process which specific elements from each of its input datasets were used to produce each of its output datasets.

In some embodiments, the illustrative system capable of generating a mapping of element-level data lineage may be utilized to determine resource intensive processes in the dataflow, for example a single process may be utilized to retrieve status updates from multiple databases concerning changes in finance for a group of consumers. Status changes to consumer finance vary significantly by location (e.g., number of consumers in California vs. Oklahoma). The system as described could generate an element-level data lineage mapping that would detect the significant resource dependency generated by location, thus allowing process dataflow re-routing and reconfiguring increasing resource efficiency and dataflow capacities.

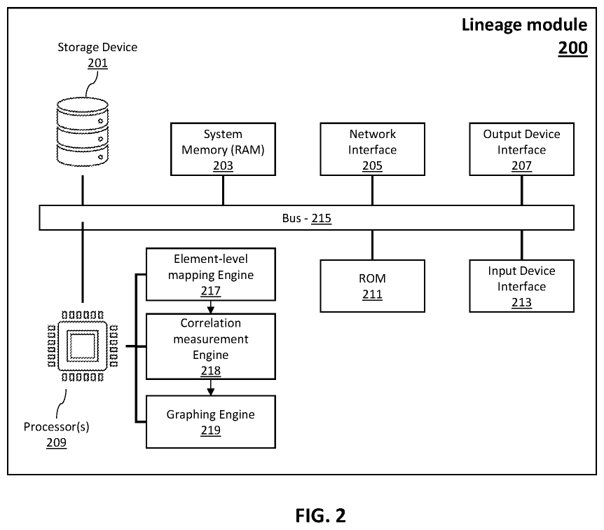

FIG. 2 depicts an exemplary block diagram of a lineage module 200 according to some embodiments. The lineage module 200 of FIG. 2 is a non-limiting example of an illustrative system configured to generate element-level data lineage. The system is capable of generating a mapping of element level data lineage. In some embodiments, the illustrative lineage module 200 may have a network interface 205 communicatively coupled to a bus 215 that may be capable of receiving data of data elements from any source.

In some embodiments, the illustrative lineage module 200 has at least one input device interface 213 (e.g., keyboard, mouse) for inputting information, at least one output device interface 207 (e.g., screen) for viewing the output, at least one system memory (RAM) 203 and at least one ROM 211 for storing access memory, at least one storage device 201 for storing a plurality of communication interaction sessions, an element-level mapping engine 217, correlations measurement engine 218, and a graphing engine 219, communicatively coupled to the at least one processor(s) 209.

In some embodiments, the lineage module 200 utilizes the at least one processor(s) 209 to determine an output data element. The output data element may be specified by a user, or it may be determined randomly. Upon determining an output data element, lineage module 200 may utilize the element-level mapping engine 217 to determine an input data element. The element-level mapping engine 217 may utilize data lineage information (as detailed above) from an SQL server integration service (SSIS) package, queries, or any other type of process such as for example, selection criteria, multi-table join operations, filters, conditional logic etc.

In some embodiments, the element-level mapping engine 217 may for example utilize data from a row and a column of a column separated value file (CVS) file of an output data element. The element-level mapping engine 217 may utilize a correlation algorithm such as a Pearson correlation, a Spearman correlation, Kolmogorov-Smirnov, or any similar algorithm for determining a correlation coefficient of an output data element to a plurality of input data elements.

In some embodiments, the illustrative lineage module 200 may determine an input data element of an output data element in the following manner. The element-level mapping engine 217 may determine an input data element is the source of an output data element (target) when a statistically significant correlation results from a correlation algorithm measurement of the row and column of the output data element and the row and column of an input data element from the plurality of input data elements. The system is not limited to determining a correlation with data of data elements in this manner, but may determine it any similar manner that yields a statistically significant relationship between data elements.

In some embodiments, the illustrative element-level mapping engine 217 may utilize any additional information about the input data element and output data element to derive a statistical correlation including the filename information, information from the header of the file including, for example, authorship, timestamp, IP address or machine operating system or other information or any combination thereof, and may combine this information or use it separately to determine a statistical correlation. The element-level mapping engine 217 may utilize the processor(s) 209 to perform a transformation on non-numerical data to enable a correlation measurement to be carried out.

The illustrative element-level mapping engine 217 is not limited to utilizing data from a CVS file, but may utilize data in any format for determining a correlation coefficient. The element-level mapping engine 217 is not limited to utilizing a single row and a single column of an output data element CVS file but may utilize a plurality of rows and columns to determine a correlation coefficient.

In some embodiments, the lineage module 200 is not limited to utilizing the element-level mapping engine 217 but may determine a correlation coefficient of an input data element and an output data element by a plurality element-level mapping engines. In some embodiments, a plurality of correlation coefficients of output data elements to input data elements are determined simultaneously by a plurality of element-level mapping engines.

In some embodiments, the illustrative lineage module 200 may utilize a correlation measurement engine 218 to determine a correlation between the interconnected data elements of the output data element that was determined to have a significant statistical relationship to an input data element.

In some embodiments, the element mapping engine 217 and the correlation measurement engine 218 may utilize the at least one processor(s) 209 to perform a t-test to determine a statistically significant relationship. In some embodiments, the correlation coefficient r of a Pearson correlation may be used to test whether the relationship between, for example, two rows and columns of two data elements is statistically significant. The sample correlation coefficient r is an estimate of rho (ρ) the Pearson correlation of all of the data elements, from the sample size, or total size of the data elements, and from coefficient r we can infer if rho (ρ) is significantly different than 0. The illustrative lineage module 200 is not limited to utilizing a t-test to determine statistical significance, but may utilize any similar algorithm to determine statistical significance.

In some embodiments, the illustrative correlation measurement engine 218 may determine a correlation between a first interconnected data element by utilizing a correlation algorithm to measure the correlation between data elements of the input data element, the output data element and a first interconnected data element. The correlation algorithm may be a Pearson correlation, a Spearman correlation, Kolmogorov-Smirnov or any similar correlation measurement algorithm.

In some embodiments, the illustrative correlation measurement engine 218 may utilize data elements that include a row and a column of, for example a CVS file and may also include filename information, information from the header of the file including authorship, timestamp, IP address or machine operating system, and the correlation measurement engine 218 may combine this information or use it separately to determine a statistical correlation.

In some embodiments, the illustrative correlation measurement engine 218 of the lineage module 200 may determine a statistically significant relationship between data elements by information in the form of a string of text. In this instance the correlation measurement engine 218 may utilize the at least one processor to transform the string to a number, binarize the string, assign a variable to the string, or any similar method of transforming the string to enable a uniform correlation measurement to be obtained.

In some embodiments the illustrative correlation measurement engine 218 may determine the positional relationship of the first interconnected data element relative to the input data element and output data element and the plurality of the interconnected data elements based at least in part on timestamp information of the data element.

In some embodiments, the illustrative correlation measurement engine 218 of the illustrative lineage module 200 may utilize the at least one processor to sort interconnected data elements based at least on the timestamp information of the data elements, but is not limited to utilizing the timestamp information of the data elements, but any other information related to the data element such as the filename information, information about from the header of the file including authorship, IP address or machine operating system, or any of the data in the data element itself.

In some embodiments, the illustrative correlation measurement engine 218 of the lineage module 200 may determine a statistical correlation of a plurality of interconnected data elements as described in the manner above by determining a correlation coefficient of each of the interconnected data elements and determining a statistically significant relationship between each of the interconnected data element to the input data element and the output data element, thus the lineage module 200 is capable of determining the data lineage of the output data element.

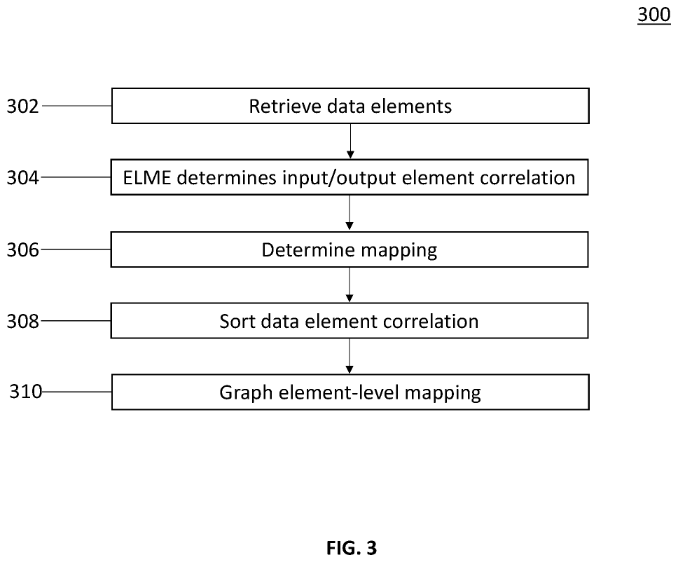

FIG. 3 is a flowchart 300 illustrating the operational steps of automatically determining data lineage from a plurality of data element interactions, in accordance with one or more embodiments of the present disclosure.

In some embodiments, at Step 302 of FIG. 3 the element-level mapping engine 217 utilizes the at least one processor(s) 209 to retrieve a first data element and a second data element from network database 108 or network database 116. The first data element representing an output data element having a plurality of interconnected nodes and edges in a graph database related to a second data element representing an input data element. In some embodiments, at Step 302 the at least one processor(s) 209 may determine a first data element to retrieve based on a preprogrammed interval, a random process, or a user 124 operating a device(s) 122 may determine a first data element and second data element to retrieve. In some embodiments, the element-level mapping engine 217 may retrieve a plurality of data elements from network database 108 and network database 116 to perform element level mapping.

In some embodiments, the at least one processor(s) 209 may retrieve the first data element and/or the second data element to perform some process. The output of the process may be used as input to a subsequent at least one processor(s) 209. The data may flow through a sequence and/or graph of the at least one processor(s) 209 to produce a final output, such as in an extract-transform-load (ETL), extract-load-transform (ELT), or other data transformation and/or processing systems.

In Step 304, the illustrative element-level mapping engine 217 utilizing, the at least one processor(s) 209, determines in a plurality of data elements having a statistically significant correlation between at least the first data element and the second data element retrieved from a network database 108 and network database 116. In some embodiments, the element-level mapping engine 217 may utilize a Pearson correlation algorithm, a Spearman correlation algorithm, Kolmogorov-Smirnov or any similar correlation algorithm capable of determining a correlation between the data of two data elements. For example, where the output of the sequence/graph of data transformations is a data object having one or more values, the original data may not be evident. Thus, the correlation determination by the element-level mapping engine 217 may determine associations between data through the transformation processes.

In some embodiments, for example, at Step 304 the element-level mapping engine 217 may determine a correlation between an input data element and an output data element by comparing for example, a row and a column of a CVS file of a first data element, to a row and a column of a second data element. The element-level mapping engine 217 may also utilize additional information associated with the data element such as (previously described) filename, header information, timestamp, IP address, machine operating system, or any similar information that might increase confidence in the correlation measurement.

In some embodiments at Step 306 the illustrative correlation measurement engine 218 of the lineage module 200 may determine mapping of the plurality of interconnected data elements of the first data element and the second data element. The correlation measurement engine 218 may utilize at least one correlation algorithm to measure data of the data elements retrieved from network database 108 and network database 116. The correlation measurement may be a Pearson correlation algorithm, a Spearman correlation algorithm, Kolmogorov-Smirnov or any similar correlation algorithm capable of determining a correlation. Accordingly, the correlations may be determined throughout a portion of or the entire data transformation sequence/graph to determine linkages between data elements.

In some embodiments, at Step 306 the illustrative correlation measurement engine 218 may determine a correlation between the interconnected data elements and the input data element and an output data element by comparing for example, a row and a column of a CSV file of a row and a column of data element of the plurality of the interconnected data elements, to the rows and columns of the first and second data elements determined to be for example the source and target data elements. The illustrative correlation measurement engine 218 may also utilize additional information associated with the data element such as (previously described) filename, header information, timestamp, IP address, machine operating system, or any similar information that might increase confidence in the correlation measurement. In doing so, the connection between any two data elements may be measured to determine the degree of confidence of correlation. Connections that exceed a threshold degree of statistical significance may be identified as correlated. Such a threshold degree may be, e.g., 90%, 95%, 97%, 99% or any other confidence level in a range of 75 to 100 percent confidence.

In some embodiments, at Step 308, the illustrative lineage module 200 may utilize the at least one processor(s) 209 to temporally sort the plurality of interconnected data elements determined to have a statistically significant relationship to the first data element and the second data element that were previously determined to be a source and a target data element.

In some embodiments, at Step 308, the illustrative lineage module 200 may utilize the at least one processor(s) 209 to sort by operation of the process performed on the plurality of interconnected data elements determined to have a statistically significant relationship to the first data element and the second data element that were previously determined to be an input data element and an output data element. In some embodiments the method of sorting is not limited but may be performed in any manner based on a row or column information of the data element, the header information of the data element, the filename, timestamp, associated IP address, or machine operating system.

In some embodiments, at Step 308, the illustrative lineage module 200 may utilize the at least one processor(s) 209 to sort by a selected input of a user 124 of a device(s) 122 the plurality of interconnected data elements determined to have a statistically significant relationship to the first data element and the second data element that were previously determined to be an input data element and an output data element. In some embodiments, at Step 308, a user 124 of a device(s) 122 may be granted access to the lineage module 200 and associated systems to perform a specified search for example, a regulator tasked with investigating the lineage of a specific output data element. The regulator in this example may define the output data element to be mapped, and the method of sorting.

In some embodiments, at Step 310, the illustrative graphing engine 219 of the lineage module 200 determines a graph of the plurality of data elements determined to have a statistically significant correlation measurement. In some embodiments, the graph may include nodes and edges in a graph database, but is not limited to a graph database, any similar graph may be used to display the data element lineage in an informative and efficient manner. In some embodiments, the nodes may represent a data element and the vertices may represent for example a requesting process to a requesting resource but the representation of nodes and edges are not limited, and can represent any similar data element or process such as for example a node may be represented by source, entity, dataflow, publish job, publish target, and edges connecting them may be represented by load, explore prepare dataflow, publish job etc. In some embodiments at Step 310, the graphing engine 219 may graph data elements into clusters or diagrams.

In some embodiments, at Step 310 where data elements are graphed by the graphing engine 219 into clusters, the clusters may provide insight into process heavy data elements for diagnostics purposes for example, a cluster with a significant numbers of vertices and nodes may indicate a dependency heavy data element (e.g., bottleneck). Once identified the dataflow can be routed to subsystems or separate modules of lineage module 200, resulting in increased efficiency and streamlining processes.

In some embodiments, at Step 310 data elements may be graphed by the illustrative graphing engine 219 into directional or bidirectional events. In some embodiments for example an element-level data element mapping may graph an input data element or node to the corresponding interconnected nodes to the output node or output data element as a series of nodes and vertices. In some instances, the output data element may be returned to the input data element for the addition of a data element or transformation, and then back through the interconnected data elements to the output data element.

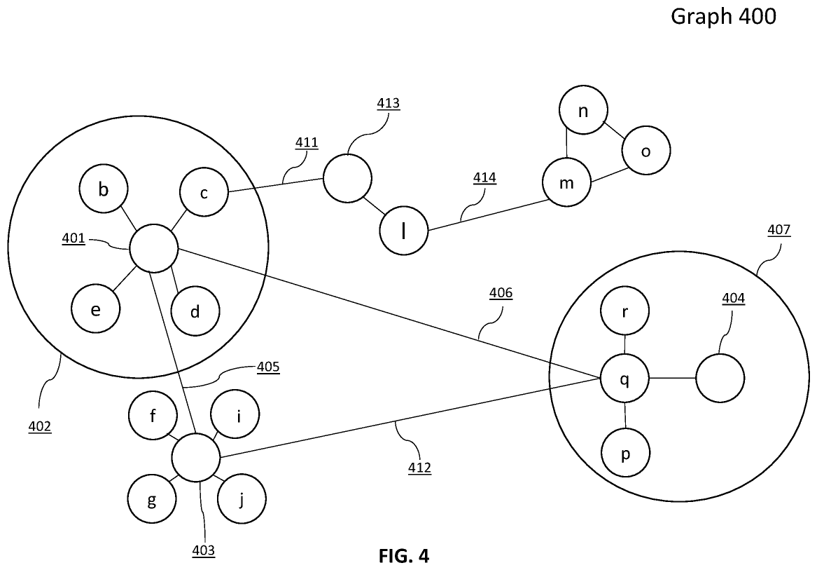

FIG. 4 is a diagram illustrating a data lineage in Graph 400, in accordance with one or more embodiments of the present disclosure. In some embodiments, the illustrative lineage module 200 may utilize the graphing engine 219 to determine a graph database representation of the statistically significant data elements of interconnected data elements of the input data element and the output data element. In some embodiments, the interconnected nodes of the input data element 401 and output data element 404 may be graphed as a series of nodes connected by vertices, the vertices representing a significant correlation between the nodes. Nodes in FIG. 4 may represent an output data element 404, and an input data element 401. Nodes in FIG. 4 may also represent the series of interconnected nodes/data element such as data element 403 and data element 413 determined to have a statistically significant relationship between the input data element 401 and the output data element 404 as determined by the at least one of the correlation algorithms of the element-level mapping engine 217 and the correlation measurement engine 218.

In some embodiments, and as previously described, the illustrative graphing engine 219 of the lineage module 200 may determine positional information, clustering information, or diagram information based on a correlation between the interconnected data elements and the input data element and an output data element by comparing for example, a row and a column of a CVS file of a row and a column of data element of the plurality of the interconnected data elements, to the rows and columns of the first and second data elements determined to be the input data element and the output data element. The illustrative correlation measurement engine 218 or the element-level mapping engine 217 may also utilize additional information associated with the data element such as filename, header information, timestamp, IP address, machine operating system, or any similar information that might increase confidence in the correlation measurement.

In some embodiments, the illustrative lineage module 200 may utilize the graphing engine 219 to graph a cluster 402 of Graph 400. In some embodiments, the cluster 402 may include the input data element 401 where data element b, data element c, data element d and data element e of cluster 402 share a correlative relationship with input data element 401 as determined by the at least one of the correlation algorithms of the element-level mapping engine 217 and the correlation measurement engine 218.

In some embodiments, the illustrative lineage module 200 may utilize the graphing engine 219 to graph the correlative relationship of input data element 401 with data element 403 illustrated by vertices/edge 405 of Graph 400. In this instance, data element 403 shares a correlative relationship as determined by the at least one of the correlation algorithms of the element-level mapping engine 217 and the correlation measurement engine 218 with data element f, data element g, data element i and data element j. In some embodiments, a statistically significant correlation of processes such as for example entity, dataflow, transform, may have been determined to have been carried out on data element 403 by data element f, data element g, data element i and data element j, indicated by the vertices/edge connecting the data elements.

In some embodiments, as illustrated by edge 412 a correlative relationship may be determined by the at least one of the correlation algorithms of the element-level mapping engine 217 and the correlation measurement engine 218 between data element 403, cluster 407, data element q, and the output data element 404.

In some embodiments, as illustrated by edge 411 a correlative relationship may be determined by the at least one of the correlation algorithms of the element-level mapping engine 217 and the correlation measurement engine 218 between data element c, data element 413, data element 1, edge 414 and data element m, data element n, and data element o. In some embodiments, interconnected data elements may be bidirectional carrying out processes on input data element c and back to input data element 401. Illustrative graphing engine 219 of lineage module 200 is not limited to graphing data lineage as illustrated as a cluster as shown in Graph 400. Illustrative graphing engine 219 of lineage module 200 may graph the correlative relationships determined by the at least one of the correlation algorithms of the element-level mapping engine 217 and the correlation measurement engine 218 between data elements in any similar manner that illustrates the data in the most efficient and easily-understandable way.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer module” and “module” or “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; TM (20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary ASR system of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

The aforementioned examples are, of course, illustrative and not restrictive.

Clause 1. A method may include: retrieving by at least one processor, a first data element for mapping an element-level mapping, the first data element representing an output data element having a plurality of interconnected nodes and edges in a graph database related to a second data element representing an input data element; utilizing, by at least one processor, an element mapping module, to determine a correlation in a graph database based at least in part on the first data element and the second data element; wherein the element mapping module is configured to: utilize at least one element-level mapping model to determine a statistical relationship between a plurality of data elements comprising a plurality of interconnected nodes and edges in a graph database; utilizing, by at least one processor, at least one element-level mapping model to determine a correlation between the first data element having interconnected nodes and edges in a graph database and a second element having interconnected nodes and edges in a graph database; utilizing, based on at least one processor, a correlation measurement model to determine correlation between each of the nodes of the first data element and each of the nodes of the second element of the plurality of data elements based on the correlation measurement; sorting, by the at least one processor, the interconnected database elements determined to have a statistically significant correlation to the input data element and the output data element; mand, graphing, by the at least one processor, the sorted graph database elements of the nodes and edges determined by the correlation measurement model.

Clause 2. The method according to clause 1, wherein the statistical relationship determined by the element-level mapping module is at least in part based on a Pearson correlation.

Clause 3. The method according to clause 1, wherein the correlation measurement model is at least in part based on a Pearson correlation.

Clause 4. The method according to clause 1, 2, or 3, wherein confidence intervals of a correlation measurement model determines at least in part the correlation measurement model.

Clause 5. The method according to clause 1, 2, 3, or 4, wherein sorting by the at least one processor of the nodes and edges determined by the correlation model is performed on nodes and edges comprising at least one transformation of the data elements.

Clause 6. The method according to clause 1, 2, 3, 4, or 5, wherein sorting by the at least one processor of the nodes and edges determined by the correlation model is based on timestamp information of the data elements.

Clause 7. The method according to clause 1, 2, 3, 4, 5, or 6, wherein sorting by the at least one processor of the nodes and edges of the data elements determined by the correlation model is based on at least one input selected by a user.

Clause 8. A system may include: non-transient computer memory, storing software instructions; and at least one processor of a first computing device associated with a user; wherein, when the at least one processor executes the software instructions, the first computing device is programmed to: receive, by at least one processor, a first data element for mapping an element-level mapping, the first data element representing an output data element having a plurality of interconnected nodes and edges in a graph database related to a second data element representing an input data element; utilize, by at least one processor, an element mapping module, to determine a correlation in a graph database based at least in part on the first data element and the second data element; wherein the element mapping module is configured to: utilize at least one element-level mapping model to determine a statistical relationship between a plurality of data elements comprising a plurality of interconnected nodes and edges in a graph database; utilize, by at least one processor, at least one element-level mapping model to determine a correlation between the first data element having interconnected nodes and edges in a graph database and a second element having interconnected nodes and edges in a graph database; utilize, based on at least one processor, a correlation measurement model to determine correlation between each of the nodes of the first data element and each of the nodes of the second element of the plurality of data elements based on the correlation measurement; sort, by the at least one processor, the interconnected database elements determined to have a statistically significant correlation to the input data element and the output data element; and, graph, by the at least one processor, the sorted graph database elements of the nodes and edges determined by the correlation measurement model.

Clause 9. The system according to clause 8, wherein the statistical relationship determined by the element-level mapping module is at least in part based on a Pearson correlation.

Clause 10. The system according to clause 8, or 9, wherein the correlation measurement model is at least in part based on a Pearson correlation.

Clause 11. The system according to clause 8, 9, or 10, wherein confidence intervals of a correlation measurement model determine at least in part the correlation measurement model.

Clause 12. The system according to clause 8, 9, 10, or 11, wherein sorting by the at least one processor of the nodes and edges determined by the correlation model is performed on nodes and edges comprising at least one transformation of the data elements.

Clause 13. The system according to clause 8, 9, 10, 11, or 12, wherein sorting by the at least one processor of the nodes and edges determined by the correlation model is based on timestamp information of the data elements.

Clause 14. The system according to clause 8, 9, 10, 11, 12, or 13, wherein sorting by the at least one processor of the nodes and edges of the data elements determined by the correlation model is based on at least one input selected by a user.

Clause 15. At least one computer-readable storage medium having encoded thereon software instructions that, when executed by at least one processor, cause the at least one processor to perform steps to: receive, by at least one processor, a first data element for mapping an element-level mapping, the first data element representing an output data element having a plurality of interconnected nodes and edges in a graph database related to a second data element representing an input data element; utilize, by at least one processor, an element mapping module, to determine a correlation in a graph database based at least in part on the first data element and the second data element; wherein the element mapping module is configured to: utilize at least one element-level mapping model to determine a statistical relationship between a plurality of data elements comprising a plurality of interconnected nodes and edges in a graph database; utilize, by at least one processor, at least one element-level mapping model to determine a correlation between the first data element having interconnected nodes and edges in a graph database and a second element having interconnected nodes and edges in a graph database; utilize, based on at least one processor, a correlation measurement model to determine correlation between each of the nodes of the first data element and each of the nodes of the second element of the plurality of data elements based on the correlation measurement; sort, by the at least one processor, the interconnected database elements determined to have a statistically significant correlation to the input data element and the output data element; and, graph, by the at least one processor, the sorted graph database elements of the nodes and edges determined by the correlation measurement model.

Clause 16. The at least one computer-readable storage medium of clause 15, wherein the element-level mapping model is at least in part based on a Pearson correlation.

Clause 17. The at least one computer-readable storage medium of clause 15, or 16, wherein the correlation measurement model is at least in part based on a Pearson correlation.

Clause 18. The at least one computer-readable storage medium of clause 15, 16, or 17, wherein confidence intervals of a correlation measurement model determine at least in part the correlation measurement model.

Clause 19. The at least one computer-readable storage medium of clause 15, 16, 17, or 18, wherein sorting by the at least one processor of the nodes and edges determined by the correlation model is performed on nodes and edges comprising at least one transformation of the data elements.

Clause 20. The at least one computer-readable storage medium of clause 15, 16, 17, 18, or 19 wherein sorting by the at least one processor of the nodes and edges determined by the correlation model is based on timestamp information of the data elements.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A computer-implemented method comprising:
retrieving, by at least one processor, an output data record comprising a plurality of first data elements, each first data element representing an output data element output from at least one transformation and having a plurality of interconnected nodes and edges in a graph database related to a second data element representing an input data element;
obtaining, by the at least one processor, at least one input data record comprising a plurality of second data elements, each second data element representing input data input into the at least one transformation;
generating, by the at least one processor, a plurality of input-output pairs, each input-output pair representing a candidate pairing of a first data element of the plurality of first data elements with a second data element of the plurality of second data elements;
utilizing, by at least one processor, an element mapping module, to determine a correlation in a graph database based at least in part on the first data element and the second data element of each input-output pair of the plurality of input-output pairs;
wherein the element mapping module is configured to:
utilize at least one element-level mapping model to determine a statistical relationship between the first data element and the second data element of each input-output pair comprising a plurality of interconnected nodes and edges in a graph database;
sorting, by the at least one processor, for each first data element of the plurality of first data elements, the plurality of second data elements based at least in part on the statistical relationship between the first data element and the second data element of each input-output pair;
determining, by the at least one processor, for each first data element, at least one correlated second data of the plurality of second data element based at least in part on the sorting to determine a statistically significant correlation between each first data element and the respective at least one correlated second data element; and
updating, by the at least one processor, the plurality of interconnected the nodes and edges in the graph database to include, for each first data element, at least one edge to the at least one correlated second data element.

2. The computer-implemented method according to claim 1, wherein the statistical relationship determined by the element-level mapping module is at least in part based on a Pearson correlation.

3. The computer-implemented method according to claim 1, further comprising utilizing a correlation measurement model based on a Pearson correlation.

4. The computer-implemented method according to claim 1, wherein confidence intervals of a correlation measurement model determines at least in part the correlation measurement model. in (Original) The computer-implemented method according to claim 1, wherein sorting by the at least one processor of the nodes and edges determined by the correlation model is performed on nodes and edges comprising at least one transformation of the data elements.

6. The computer-implemented method according to claim 1, wherein sorting by the at least one processor of the nodes and edges determined by the correlation model is based on timestamp information of the data elements.

7. The computer-implemented method according to claim 1, wherein sorting by the at least one processor of the nodes and edges of the data elements determined by the correlation model is based on at least one input selected by a user.

8. A system comprising:
a non-transient computer memory, storing software instructions; and
at least one processor of a first computing device associated with a user;
wherein, when the at least one processor executes the software instructions, the first computing device is programmed to:
receive, by at least one processor, an output data record comprising a plurality of first data elements, each first data element representing an output data element output from at least one transformation and having a plurality of interconnected nodes and edges in a graph database related to a second data element representing an input data element;
obtain, by the at least one processor, at least one input data record comprising a plurality of second data elements, each second data element representing input data input into the at least one transformation;
generate, by the at least one processor, a plurality of input-output pairs, each input-output pair representing a candidate pairing of a first data element of the plurality of first data elements with a second data element of the plurality of second data elements;
utilize, by at least one processor, an element mapping module, to determine a correlation in a graph database based at least in part on the first data element and the second data element of each input-output pair of the plurality of input-output pairs;
wherein the element mapping module is configured to:
utilize at least one element-level mapping model to determine a statistical relationship between the first data element and the second data element of each input-output pair comprising a plurality of interconnected nodes and edges in a graph database;
sort, by the at least one processor, for each first data element of the plurality of first data elements, the plurality of second data elements based at least in part on the statistical relationship between the first data element and the second data element of each input-output pair;
determine, by the at least one processor, for each first data element, at least one correlated second data of the plurality of second data element based at least in part on the sorting to determine a statistically significant correlation between each first data element and the respective at least one correlated second data element;
update, by the at least one processor, the plurality of interconnected the nodes and edges in the graph database to include, for each first data element, at least one edge to the at least one correlated second data element.

9. The system of claim 8, wherein the statistical relationship determined by the element-level mapping module is at least in part based on a Pearson correlation.

10. The system of claim 8, wherein, when the at least one processor executes the software instructions, the first computing device is further programmed to utilize a correlation measurement model based on a Pearson correlation.

11. The system of claim 8, wherein confidence intervals of a correlation measurement model determine at least in part the correlation measurement model.

12. The system of claim 8, wherein sorting by the at least one processor of the nodes and edges determined by the correlation model is performed on nodes and edges comprising at least one transformation of the data elements.

13. The system of claim 8, wherein sorting by the at least one processor of the nodes and edges determined by the correlation model is based on timestamp information of the data elements.

14. The system of claim 8, wherein sorting by the at least one processor of the nodes and edges of the data elements determined by the correlation model is based on at least one input selected by a user.

15. At least one computer-readable storage medium having encoded thereon software instructions that, when executed by at least one processor, cause the at least one processor to perform steps to:
receive, by at least one processor, an output data record comprising a plurality of first data elements, each first data element representing an output data element output from at least one transformation and having a plurality of interconnected nodes and edges in a graph database related to a second data element representing an input data element;
obtain, by the at least one processor, at least one input data record comprising a plurality of second data elements, each second data element representing input data input into the at least one transformation;
generate, by the at least one processor, a plurality of input-output pairs, each input-output pair representing a candidate pairing of a first data element of the plurality of first data elements with a second data element of the plurality of second data elements;
utilize, by at least one processor, an element mapping module, to determine a correlation in a graph database based at least in part on the first data element and the second data element of each input-output pair of the plurality of input-output pairs;
wherein the element mapping module is configured to:
utilize at least one element-level mapping model to determine a statistical relationship between the first data element and the second data element of each input-output pair comprising a plurality of interconnected nodes and edges in a graph database;
sort, by the at least one processor, for each first data element of the plurality of first data elements, the plurality of second data elements based at least in part on the statistical relationship between the first data element and the second data element of each input-output pair;
determine, by the at least one processor, for each first data element, at least one correlated second data of the plurality of second data element based at least in part on the sorting to determine a statistically significant correlation between each first data element and the respective at least one correlated second data element;
update, by the at least one processor, the plurality of interconnected the nodes and edges in the graph database to include, for each first data element, at least one edge to the at least one correlated second data element.

16. The at least one computer-readable storage medium of claim 15, wherein the element-level mapping model is at least in part based on a Pearson correlation.

17. The at least one computer-readable storage medium of claim 15, wherein the steps further comprising utilize a correlation measurement model based on a Pearson correlation.

18. The at least one computer-readable storage medium of claim 15, wherein confidence intervals of a correlation measurement model determine at least in part the correlation measurement model.

19. The at least one computer-readable storage medium of claim 15, wherein sorting by the at least one processor of the nodes and edges determined by the correlation model is performed on nodes and edges comprising at least one transformation of the data elements.

20. The at least one computer-readable storage medium of claim 15, wherein sorting by the at least one processor of the nodes and edges determined by the correlation model is based on timestamp information of the data elements.
